(19) United States
(12) Patent Application Publication
(10) Pub. No.: US 2006/0060060 A1
(43) Pub. Date: Mar. 23, 2006

(54) Band and orchestra musical instrument case

(76) Inventors: Richard K. Breske, Mishawaka, IN (US); Marshal D. Hernandez, Austin, TX (US)

Correspondence Address: FISH & RICHARDSON PC, P.O. BOX 1022, MINNEAPOLIS, MN, 55440-1022, US

(21) Appl. No.: 11/228,871

(22) Filed: Sep. 15, 2005

Related U.S. Application Data
(60) Provisional application No. 60/611,403, filed on Sep. 20, 2004.

(51) Int. Cl. G10D 7/10

(52) U.S. Cl. 84/387 A

(57) ABSTRACT

A band and orchestra musical instrument case has a body and a cover. The body and cover together define a volume for receiving and containing a musical instrument during transport and storage. The case defines a case outer wall surface and further has a pouch member mounted upon the case outer wall surface. The pouch member defines one or more pockets, e.g. a mesh pocket, e.g. for carrying a water bottle, and a pocket with a closure, e.g., for carrying a CD player and other personal items.

### TECHNICAL FIELD

This application claims benefit from U.S. Provisional Patent Application No. 60/611,403, filed Sep. 20, 2004.

The disclosure relates to cases for transportation and storage of band and orchestra musical instruments.

### BACKGROUND

Cases for transportation and storage of band and orchestra musical instruments are known. Typical cases consist of a body and a cover that together define a volume for receiving a musical instrument. The cover is typically attached upon the body of the case, e.g. with one or more hinges, with a clasp or the like for securing the case in closed condition. The case may be hard-sided, formed, e.g. of cardboard, wood, metal, hard plastic, or the like, or, in some instances, the case may be soft-sided, formed, e.g. of soft or flexible plastic, cloth, or the like, or some combination of both. The inner surfaces of the case are most often lined or padded to protect the instrument against damage or scratching, with the padding defining a cavity custom-shaped for snuggly receiving a particular model instrument, thus to further protect the instrument against scratching or damage, e.g. as the case is jostled during transport or storage.

### SUMMARY

According to the disclosure, a band and orchestra musical instrument case comprises a body and a cover, the body and cover together defining a volume for receiving and containing a musical instrument during transport and storage. The musical instrument case defines a case outer wall surface, and further comprises a pouch member mounted upon the case outer wall surface.

Preferred implementations of the disclosure may include one or more of the following additional features. The cover is hingedly attached upon the body and moveable between a first, open position and a second, closed position. The case further comprises a securement element, e.g. a clasp, for securing the cover in the second, closed position. The case comprises hard side regions, soft side regions, or combinations thereof. The pouch member comprises at least one mesh pocket. In one implementation, the mesh pocket is sized and constructed for transport of a water bottle. The pouch member comprises at least one pocket with a releasable closure, e.g. a zipper, button, snap, clasp, or hook-and-loop type cooperative fastener elements. At least one pocket with a releasable closure is sized and constructed for transport of a CD player. The pouch member comprises multiple pockets. The case outer wall surface comprises a cover outer wall surface.

The details of one or more implementations of the disclosure are set forth in the accompanying drawings and the description below. Other features, objects, and advantages of the disclosure will be apparent from the description and drawings, and from the claims.

### DESCRIPTION OF DRAWINGS

FIG. 1 is a first perspective view of a band and orchestra musical instrument case of the disclosure, with a pouch member for transport and storage of personal items mounted upon an outer surface of the case cover.

FIG. 2 is a similar first plan view of the musical instrument case and pouch member of FIG. 1.

FIG. 3 is a reverse perspective view of the musical instrument case of FIG. 1, with the case shown in open condition and containing a musical instrument, e.g., in this instance, a trumpet.

Like reference symbols in the various drawings indicate like elements.

### DETAILED DESCRIPTION

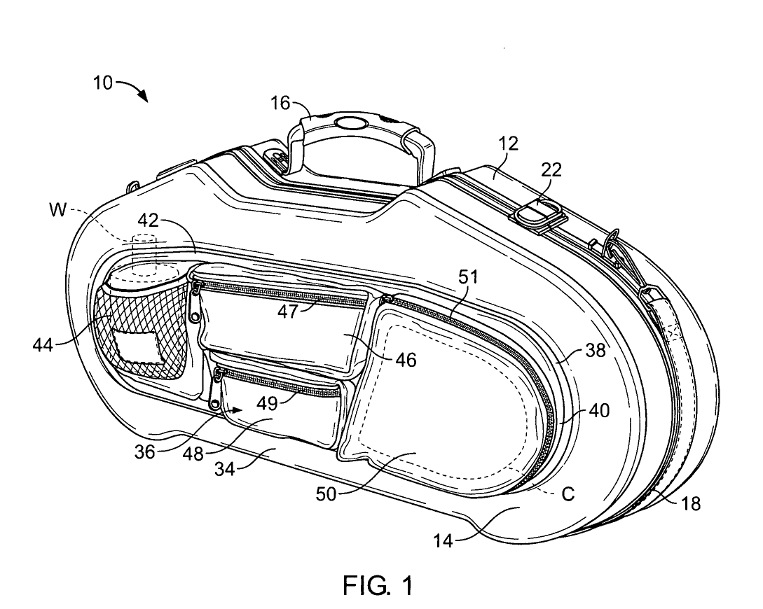

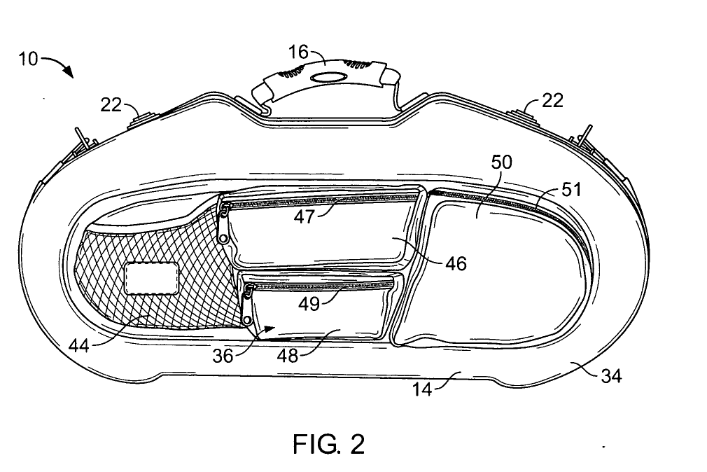

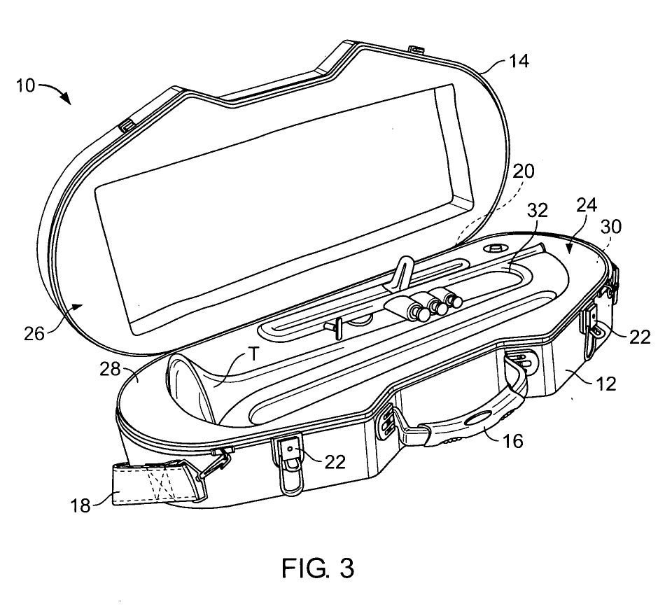

Referring to FIGS. 1-3, a band and orchestra musical instrument case 10 has a body 12 and a cover 14, formed, e.g. of hard molded plastic or other suitable material, with a carrying handle 16 and carrying strap 18. The cover 14 is attached upon the body 12 by a hinge 20 (indicated by dashed lines in FIG. 3) for movement between a first, closed position (FIGS. 1 and 2) and a second, open position (FIG. 3). Securement elements, e.g. clasps 22, are provided for securing the cover 14 in the first, closed position. The body 12 and cover 14 together define a volume 24 for receiving and containing a musical instrument (by way of example only, a trumpet, T, is shown in FIG. 3) during transport and storage. The inner surfaces 26 of the case 10 are lined, e.g. with soft cloth or fleece 28, and padded, e.g. with foam or fiber 30, to protect the musical instrument, T, against damage or scratching. The padding typically defines a cavity 32 custom sized and shaped for snuggly receiving the particular model instrument intended to be stored and transported with that case 10. The musical instrument is thus further protected against scratching or damage, e.g. as the case 10 containing the instruments is jostled during transport or storage.

Referring to FIGS. 1 and 2, the musical instrument case 10 defines a case outer wall surface 34, and a pouch member 36 is releasably attached upon the case outer wall surface, typically a wall surface of the cover 14, as shown. The pouch member 36, formed, e.g. of nylon, plastic or other suitable flexible or fabric material, is preferably securely but removably mounted upon the case outer wall surface 34 in a manner to permit a purchaser or user to customize the instrument case to his or her personal taste, e.g., by selection of a pouch member having a particular arrangement or selection of pockets and/or by colors, designs, logos, insignias, materials of construction, etc. In one implementation, a metal insert 38 for receiving the pouch member 36 is molded into or otherwise fixedly attached upon the case inner wall surface 34 and exposed in such a way so that a rim element 40 of selected pouch member 36 is fastened to the metal insert 38, e.g. with screws 42.

The pouch member 36 defines one or multiple pockets for storage and transport of personal items, such as cellular telephones, pens and pencils, make-up, snacks, etc. For example, in the implementation of FIGS. 1 and 2, the pouch member 36 defines an expandable mesh pocket 44, which is sized and constructed for transporting a water bottle, W (indicated by dashed lines in FIG. 1). The pouch member 36 also defines three additional pockets 46, 48, 50, each secured by releasable closures 47, 49, 51, which in this implementation are zippers. In particular, pocket 50, secured by zipper 51, is sized and constructed, including with additional padding in the outer flap 52, for transport of a CD player, C (indicated by dashed lines in FIG. 1).

A number of implementations of the disclosure have been described. Nevertheless, it will be understood that various modifications may be made without departing from the spirit and scope of the disclosure. For example, instruments cases of the disclosure are suited for use with all manner of band and orchestra musical instruments. Instrument cases of the disclosure may be formed with hard sides or hard side regions or soft sides or soft side regions, or with any combinations thereof, and may be formed of any suitable material, e.g. case hard sides may be formed from cardboard, wood, metal, hard plastic, or other material, and case soft sides may be formed of soft or flexible plastic, cloth, or other material. The pouch member 36 similarly may be formed of any suitable material and different pouch members may be used interchangeably, e.g. at the whim or mood of the instrument case user. The pouch member may be mounted upon the outer wall surface 34 of the case 10 by any suitable mounting arrangement. Alternatively, the pouch member may be releasably secured upon the outer wall surface 34 of the case 10, e.g. by hook-and-loop type cooperative fastener elements or other suitable releasable fastener arrangements. Releasable closures for the pockets of the pouch member 30 may alternatively or additionally take the form of buttons, snaps, clasps, hook-and-loop type cooperative fastener elements, or the like. Accordingly, other implementations are within the scope of the following claims.

What is claimed is:

1. A band and orchestra musical instrument case, comprising a body and a cover, the body and cover together defining a volume for receiving and containing a musical instrument during transport and storage, the musical instrument case defining a case outer wall surface and further comprising a pouch member mounted upon said case outer wall surface.

2. The band and orchestra musical instrument case of claim 1, wherein said cover is hingedly-attached upon said body and moveable between a first, open position and a second, closed position.

3. The band and orchestra musical instrument case of claim 2, wherein said case further comprises a securement element for securing said cover in the second, closed position.

4. The band and orchestra musical instrument case of claim 3, wherein said securement element comprises a clasp.

5. The band and orchestra musical instrument case of claim 1, wherein said case comprises one or more hard side regions.

6. The band and orchestra musical instrument case of claim 1 or claim 5, wherein said case comprises one or more soft side regions.

7. The band and orchestra musical instrument case of claim 1, wherein said pouch member comprises at least one mesh pocket.

8. The band and orchestra musical instrument case of claim 7, wherein said at least one mesh pocket is sized and constructed for transport of a water bottle.

9. The band and orchestra musical instrument case of claim 1 or claim 7, wherein said pouch member comprises at least one pocket with a releasable closure.

10. The band and orchestra musical instrument case of claim 9, wherein at least one said releasable closure is selected from the group consisting of zipper, button, snap, clasp, and hook-and-loop type cooperative fastener elements.

11. The band and orchestra musical instrument case of claim 9, wherein said at least one pocket with a releasable closure is sized and constructed for transport of a personal CD player.

12. The band and orchestra musical instrument case of claim 1, wherein said pouch member comprises multiple pockets.

13. The band and orchestra musical instrument case of claim 1, wherein said pouch member is releasably mounted upon said case outer wall surface.

14. The band and orchestra musical instrument case of claim 1, wherein said case outer wall surface comprises a cover outer wall surface.
